(19) United States
(12) Patent Application Publication
(10) Pub. No.: US 2026/0128554 A1
(43) Pub. Date: May 7, 2026

(54) SHIELDED CONNECTOR AND CONNECTOR BODY

(71) Applicant: JAPAN AVIATION ELECTRONICS INDUSTRY, LIMITED, Tokyo (JP)

(72) Inventor: Tomoyuki HIRANO, Tokyo (JP)

(73) Assignee: JAPAN AVIATION ELECTRONICS INDUSTRY, LIMITED, Tokyo (JP)

(21) Appl. No.: 19/334,993

(22) Filed: Sep. 22, 2025

(30) Foreign Application Priority Data
Nov. 1, 2024 (JP) 2024-193168

(51) Int. Cl. H01R 13/6582; H01R 13/508; H01R 13/6597; H01R 13/6598

(52) U.S. Cl. CPC H01R 13/6582; H01R 13/508; H01R 13/6597; H01R 13/6598

(57) ABSTRACT

A shielded connector comprises a connector body and a spring component. The shielded connector is, at least in part, accommodated in a case when the shielded connector is used. The connector body comprises a shielding shell made of die cast metal. The shielding shell has a shell body and a standing portion. The spring component has a first spring, a second spring and a facing portion. The first spring is resiliently deformable. The first spring is brought into contact with the case when the shielded connector is used. The second spring is resiliently deformable. Under an attached state where the spring component is attached to the connector body, the second spring is in contact with the standing portion in a direction intersecting with an up-down direction. Under the attached state, the facing portion faces or is in contact with the ceiling surface in the up-down direction.

### CROSS REFERENCE TO RELATED APPLICATIONS

This application is based on and claims priority under 35 U.S.C. § 119 to Japanese Patent Applications No. JP 2024-193168 filed Nov. 1, 2024, the contents of which are incorporated herein in their entirety by reference.

### BACKGROUND OF THE INVENTION

This invention relates to a shielded connector comprising a shielding shell made of die cast metal.

Referring to FIG. 27, JPA 2023-18174 (Patent Document 1) discloses a connector 900, or a shielded connector 900, of this type. The shielded connector 900 comprises a housing 910, a die cast member 920, or a shielding shell 920, and terminals 930, or signal contacts 930. The shielding shell 920 surrounds the signal contacts 930 with no gap in a plane perpendicular to an X-direction, or to a front-rear direction. This enables the shielded connector 900 of Patent Document 1 to have good shielding characteristics.

When a shielded connector such as the shielded connector 900 of Patent Document 1 is used, the shielded connector is mounted on a circuit board, which is placed in a case, under a state where the shielded connector is, at least in part, accommodated in the case. In addition, the shielded connector such as the shielded connector 900 of Patent Document 1 is normally configured so that a shielding shell of the shielded connector is connected to the case in order that the shielded connector has better shielding characteristics. However, it might be difficult to connect the shielding shell to the case if the shielding shell is made of die cast metal.

### SUMMARY OF THE INVENTION

It is therefore an object of the present invention to provide a shielded connector comprising a shielding shell made of die cast metal, wherein: the shielded connector has good shielding characteristics because the shielded connector comprises the shielding shell; and the shielding shell is easily connectable to a case.

One aspect (first aspect) of the present invention provides a shielded connector comprising a connector body and a spring component. The shielded connector is, at least in part, accommodated in a case when the shielded connector is used. The connector body comprises a shielding shell made of die cast metal. The shielding shell has a shell body and a standing portion. The shell body has a ceiling surface. The standing portion extends upward in an up-down direction from the ceiling surface. The spring component is attached to the connector body. The spring component has a first spring, a second spring and a facing portion. The first spring is resiliently deformable. The first spring is brought into contact with the case when the shielded connector is used. The second spring is resiliently deformable. Under an attached state where the spring component is attached to the connector body, the second spring is in contact with the standing portion in a direction intersecting with the up-down direction. Under the attached state, the facing portion faces or is in contact with the ceiling surface in the up-down direction.

Another aspect (second aspect) of the present invention provides a shielded connector comprising a connector body and a spring component. The shielded connector is, at least in part, accommodated in a case when the shielded connector is used. The connector body comprises a shielding shell made of die cast metal. The shielding shell has a shell body. The shell body has a ceiling surface. The spring component is attached to the connector body. The spring component has a first spring, a second spring and a facing portion. The first spring is resiliently deformable. The first spring is brought into contact with the case when the shielded connector is used. The second spring is resiliently deformable. Under an attached state where the spring component is attached to the connector body, the second spring is in contact with the shielding shell in a direction intersecting with the up-down direction. Under the attached state, the facing portion faces or is in contact with the ceiling surface in the up-down direction.

Still another aspect (third aspect) of the present invention provides a connector body which can form a shielded connector by attaching a spring component to the connector body. When the shielded connector is used, the shielded connector is, at least in part, accommodated in a case and is connected to the case. The connector body comprises a shielding shell made of die cast metal. The shielding shell has a shell body and a standing portion. The shell body has a ceiling surface. The standing portion extends upward in an up-down direction from the ceiling surface. The standing portion is brought into contact with the spring component when the spring component is attached to the connector body.

The shielded connector of the present invention is configured as follows: the shielded connector comprises the connector body and the spring component; the connector body comprises the shielding shell made of the die cast metal; the shielding shell has the shell body and the standing portion; the spring component has the first spring, the second spring and the facing portion; the first spring is resiliently deformable; the first spring is brought into contact with the case when the shielded connector is used; the second spring is resiliently deformable; and, under the attached state where the spring component is attached to the connector body, the second spring is in contact with the standing portion in the direction intersecting with the up-down direction. Accordingly, the shielded connector of the present invention is configured so that, when the shielded connector is used, the second spring of the spring component makes resilient contact with the standing portion of the shielding shell made of the die cast metal while the first spring of the spring component makes resilient contact with the case. Specifically, the shielded connector of the present invention is configured as follows: the shielded connector has good shielding characteristics because the shielded connector comprises the shielding shell made of the die cast metal; and the shielding shell is easily connectable to the case.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a shielded connector according to an embodiment of the present invention. In the figure, a spring component is attached to a connector body.

FIG. 2 is a rear view showing the shielded connector of FIG. 1.

FIG. 3 is a side view showing the shielded connector of FIG. 1. In the figure, a case is illustrated by dotted line.

FIG. 4 is another perspective view showing the shielded connector of FIG. 1. In the figure, an inner housing and signal contacts are omitted. Additionally, a part of the shielded connector is enlarged and illustrated in the figure.

FIG. 5 is an exploded, perspective view showing the shielded connector of FIG. 1.

FIG. 6 is a perspective view showing the connector body which is included in the shielded connector of FIG. 1.

FIG. 7 is a top view showing an outer housing which is included in the shielded connector of FIG. 5.

FIG. 8 is a bottom view showing the outer housing of FIG. 7.

FIG. 9 is a side view showing the outer housing of FIG. 7.

FIG. 10 is a rear view showing the outer housing of FIG. 7.

FIG. 11 is a front view showing a shielding shell which is included in the shielded connector of FIG. 5.

FIG. 12 is a top view showing the shielding shell of FIG. 11.

FIG. 13 is a bottom view showing the shielding shell of FIG. 11.

FIG. 14 is a side view showing the shielding shell of FIG. 11.

FIG. 15 is a rear view showing the shielding shell of FIG. 11.

FIG. 16 is a front view showing the spring component which is included in the shielded connector of FIG. 5. In the figure, the spring component is in a state before the spring component is attached to the connector body, and each of attaching portions of the spring component is not completely bent.

FIG. 17 is a top view showing the spring component of FIG. 16.

FIG. 18 is a bottom view showing the spring component of FIG. 16.

FIG. 19 is a side view showing the spring component of FIG. 16.

FIG. 20 is a rear view showing the spring component of FIG. 16.

FIG. 21 is a rear view showing a first modification of the shielded connector of FIG. 2. In the figure, a spring component is attached to a connector body.

FIG. 22 is a perspective view showing the shielded connector of FIG. 21. In the figure, an inner housing and signal contacts are omitted.

FIG. 23 is another perspective view showing the shielded connector of FIG. 22.

FIG. 24 is a rear view showing a second modification of the shielded connector of FIG. 2. In the figure, a spring component is attached to a connector body.

FIG. 25 is a side view showing the shielded connector of FIG. 24.

FIG. 26 is a perspective view showing the shielded connector of FIG. 24. In the figure, an inner housing and signal contacts are omitted.

FIG. 27 is an exploded, perspective view showing a connector of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

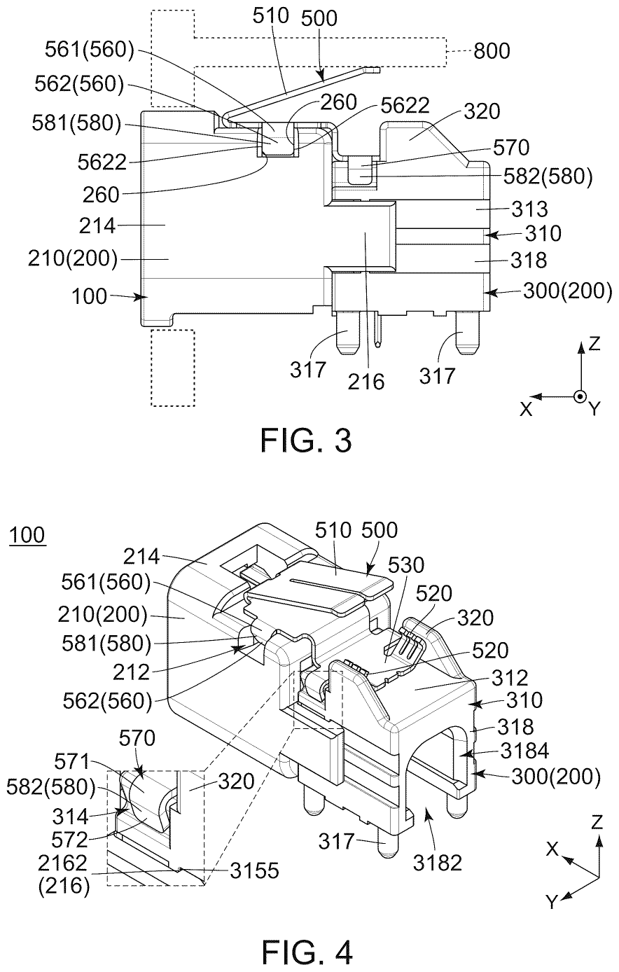

Referring to FIG. 3, a shielded connector 100 according to an embodiment of the present invention is, at least in part, accommodated in a case 800 when the shielded connector 100 is used. The shielded connector 100 is connected to the case 800 when the shielded connector 100 is used. When the shielded connector 100 is used, the shielded connector 100 is mounted on a circuit board (not shown) which is placed in the case 800. The shielded connector 100 is mateable along a front-rear direction with a mating connector (not shown) which is positioned forward of the shielded connector 100 in the front-rear direction. In the present embodiment, the front-rear direction is an X-direction. Specifically, forward is a positive X-direction while rearward is a negative X-direction.

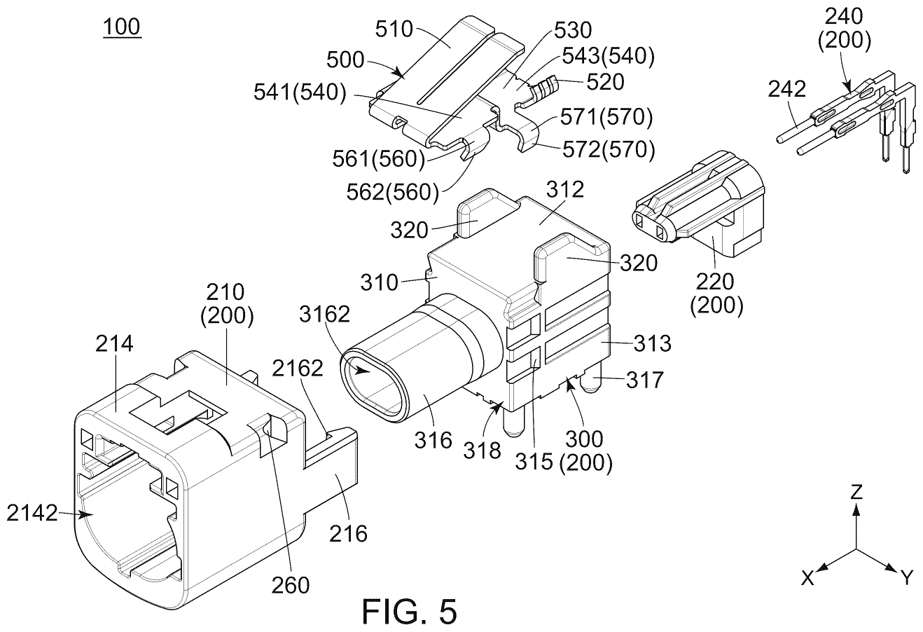

As shown in FIG. 5, the shielded connector 100 of the present embodiment comprises a connector body 200 and a spring component 500.

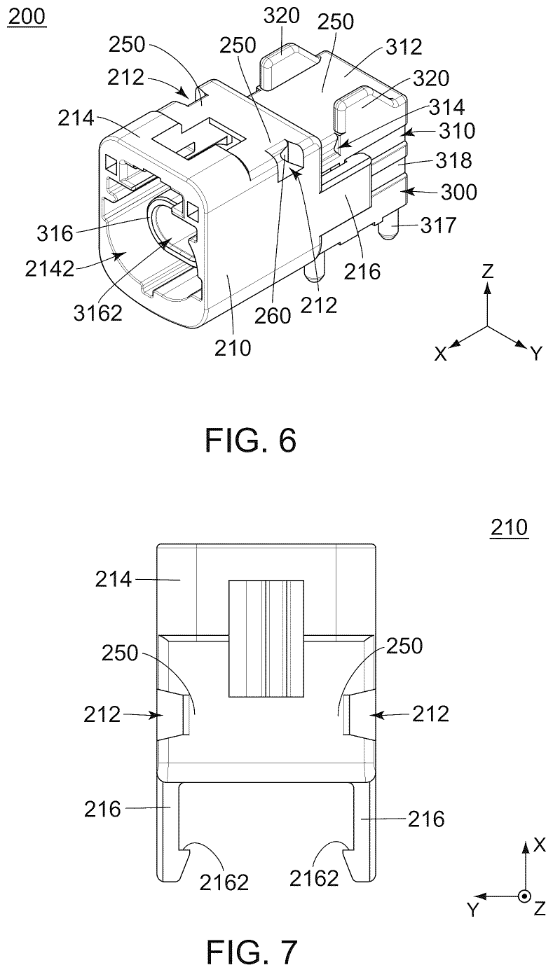

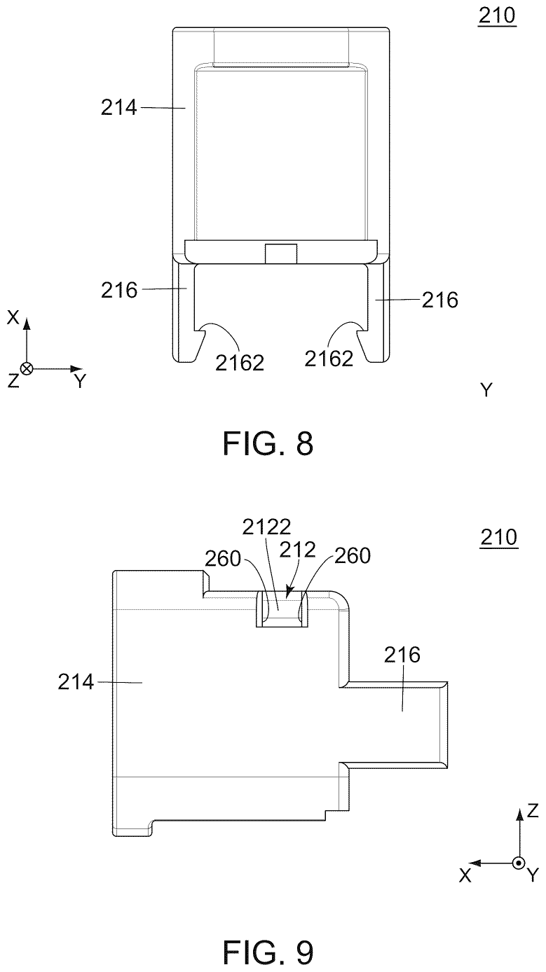

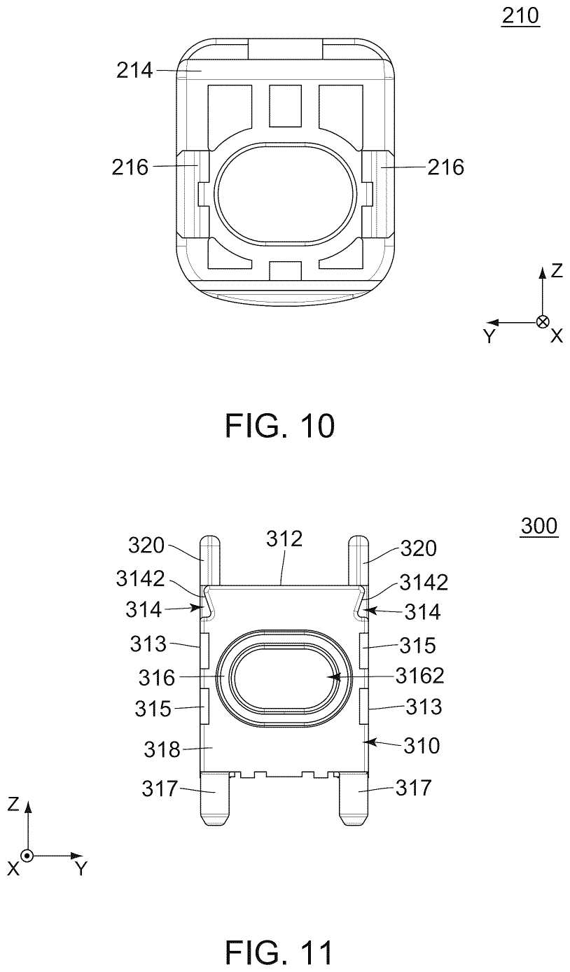

Referring to FIG. 4, the connector body 200 of the present embodiment can form the shielded connector 100 by attaching the spring component 500 to the connector body 200. As shown in FIG. 6, the connector body 200 comprises a shielding shell 300 made of die cast metal.

As shown in FIG. 11, the shielding shell 300 of the present embodiment has a shell body 310 and standing portions 320. However, the present invention is not limited thereto. Specifically, the shielding shell 300 may have no standing portion 320.

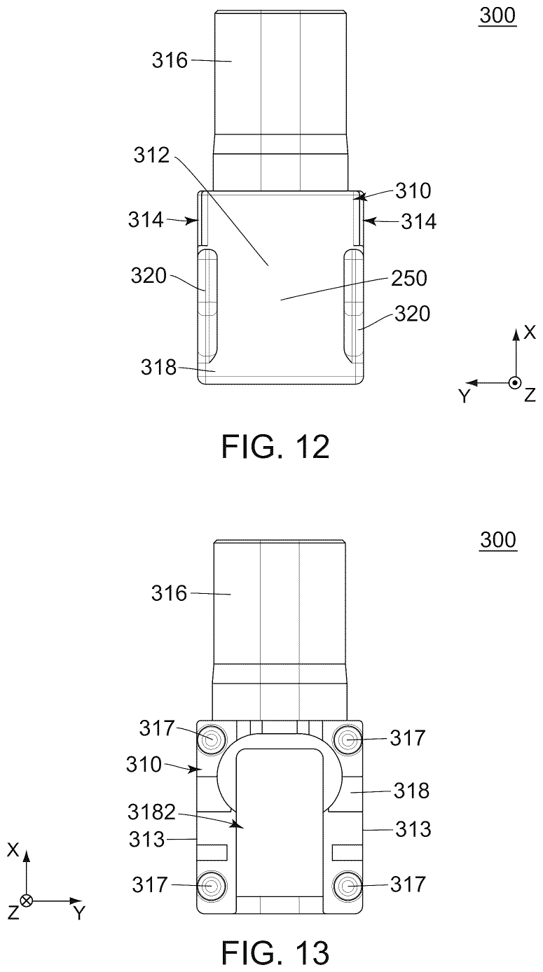

As shown in FIG. 12, the shell body 310 of the present embodiment defines a front end of the shielding shell 300 in the front-rear direction. The shell body 310 defines a rear end of the shielding shell 300 in the front-rear direction.

As shown in FIG. 12, the shell body 310 has a ceiling surface 312.

As shown in FIG. 15, the ceiling surface 312 of the present embodiment faces upward in an up-down direction. The ceiling surface 312 is a plane intersecting with the up-down direction. More specifically, the ceiling surface 312 is the plane perpendicular to the up-down direction. The ceiling surface 312 defines an upper end of the shell body 310 in the up-down direction. In the present embodiment, the up-down direction is a Z-direction. Specifically, upward is a positive Z-direction while downward is a negative Z-direction.

As shown in FIG. 11, the shell body 310 has two side portions 313.

As shown in FIG. 11, the side portions 313 of the present embodiment define opposite ends, respectively, of the shell body 310 in a lateral direction. In the present embodiment, the lateral direction is a Y-direction. In addition, the lateral direction is also referred to as a right-left direction. Specifically, it is assumed that rightward is a negative Y-direction while leftward is a positive Y-direction. Each of the side portions 313 has a shielding shell attached portion 314, or an attached portion 314.

As shown in FIG. 11, the shell body 310 of the present embodiment has two of the shielding shell attached portions 314. The two shielding shell attached portions 314 are positioned away from each other in the lateral direction. Each of the shielding shell attached portions 314 is recessed inward in the lateral direction. Each of the shielding shell attached portions 314 has a shielding shell regulating surface 3142.

As shown in FIG. 11, the shielding shell regulating surface 3142 of the present embodiment intersects with both the up-down direction and the lateral direction. More specifically, the shielding shell regulating surface 3142 is oblique to both the up-down direction and the lateral direction. The shielding shell regulating surface 3142 is a surface which faces downward in the up-down direction and outward in the lateral direction. The shielding shell regulating surface 3142 extends upward in the up-down direction and outward in the lateral direction.

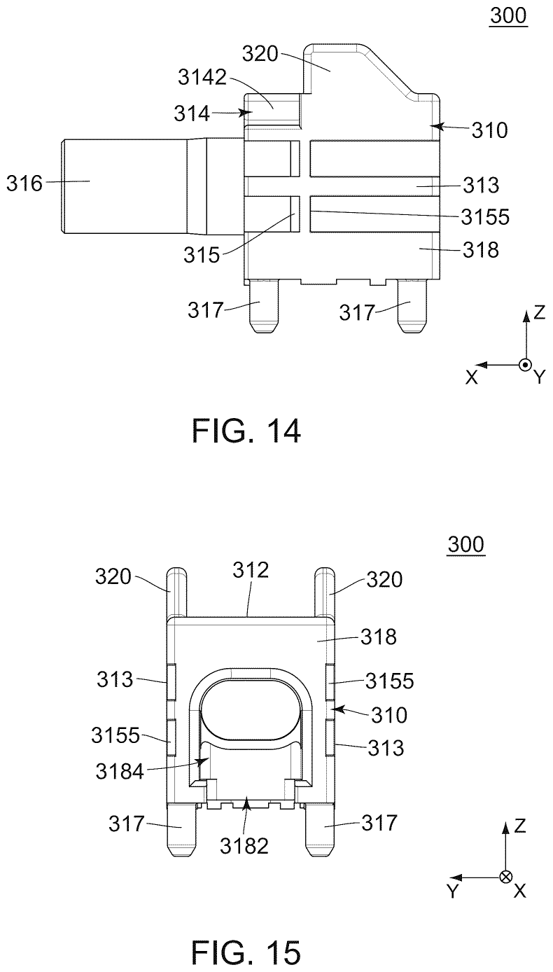

As shown in FIG. 14, the side portion 313 has a guide surface 315 and an engaged surface 3155.

As shown in FIG. 14, the guide surface 315 of the present embodiment intersects with both the front-rear direction and the lateral direction. More specifically, the guide surface 315 is oblique to both the front-rear direction and the lateral direction. The guide surface 315 is a surface which faces forward in the front-rear direction and outward in the lateral direction. The guide surface 315 extends forward in the front-rear direction and inward in the lateral direction. The guide surface 315 is positioned below the shielding shell attached portions 314 in the up-down direction. Specifically, the guide surface 315 is positioned just below the shielding shell attached portions 314 in the up-down direction. The guide surface 315 is positioned forward of the engaged surface 3155 in the front-rear direction.

As shown in FIG. 15, the engaged surface 3155 of the present embodiment intersects with the front-rear direction. More in detail, the engaged surface 3155 is perpendicular to the front-rear direction. The engaged surface 3155 faces rearward in the front-rear direction. The engaged surface 3155 is positioned below the shielding shell attached portions 314 in the up-down direction. The engaged surface 3155 is positioned rearward of the shielding shell attached portions 314 in the front-rear direction. The engaged surface 3155 is positioned rearward of the guide surface 315 in the front-rear direction.

As shown in FIG. 12, the shell body 310 has a cylindrical portion 316.

As shown in FIG. 5, the cylindrical portion 316 of the present embodiment has a hollow, cylindrical shape extending in the front-rear direction. The cylindrical portion 316 has an opening 3162 at its front end in the front-rear direction. As shown in FIG. 12, the cylindrical portion 316 is positioned forward of the ceiling surface 312 in the front-rear direction. As shown in FIG. 14, the cylindrical portion 316 is positioned forward of any of the side portions 313 in the front-rear direction. The cylindrical portion 316 is positioned below the shielding shell attached portion 314 in the up-down direction. The cylindrical portion 316 is positioned forward of the shielding shell attached portion 314 in the front-rear direction. The cylindrical portion 316 is positioned forward of the guide surface 315 in the front-rear direction. The cylindrical portion 316 is positioned forward of the engaged surface 3155 in the front-rear direction. The cylindrical portion 316 defines a front end of the shell body 310 in the front-rear direction.

As shown in FIG. 14, the shell body 310 has a box-like portion 318.

As shown in FIG. 14, the box-like portion 318 of the present embodiment is positioned rearward of the cylindrical portion 316 in the front-rear direction. The box-like portion 318 is coupled with the cylindrical portion 316. As shown in FIG. 15, all of the ceiling surface 312 and the side portions 313 are provided on the box-like portion 318. As shown in FIG. 4, the box-like portion 318 has a first opening portion 3182 and a second opening portion 3184. The first opening portion 3182 is opened downward in the up-down direction. The second opening portion 3184 is opened rearward in the front-rear direction.

As shown in FIG. 13, the shell body 310 has fixed portions 317.

As shown in FIG. 14, each of the fixed portions 317 of the present embodiment extends downward in the up-down direction from the box-like portion 318. The fixed portion 317 defines a lower end of the shell body 310 in the up-down direction. Referring to FIG. 3, each of the fixed portions 317 is connected to a grounding portion (not shown) of the circuit board when the shielded connector 100 is mounted on the circuit board which is placed in the case 800.

As shown in FIG. 15, the number of the standing portions 320 of the present embodiment is two. Specifically, the shielding shell 300 is provided with the two standing portions 320. However, the present invention is not limited thereto. The number of the standing portion 320 may be one. The two standing portions 320 are positioned away from each other in the lateral direction perpendicular to the up-down direction. As shown in FIG. 14, the standing portion 320 is positioned above the side portion 313 in the up-down direction. The standing portion 320 is positioned above the shielding shell attached portion 314 in the up-down direction. The standing portion 320 is positioned rearward of the shielding shell attached portion 314 in the front-rear direction. The standing portion 320 is positioned rearward of the guide surface 315 in the front-rear direction. The standing portion 320 is positioned rearward of the cylindrical portion 316 in the front-rear direction. The standing portion 320 is positioned above the cylindrical portion 316 in the up-down direction.

As shown in FIG. 15, each of the standing portions 320 extends upward from the ceiling surface 312 of the shell body 310 in the up-down direction. More in detail, each of the standing portions 320 extends in a plane defined by the front-rear direction and the up-down direction. However, the present invention is not limited thereto. Specifically, the standing portion 320 may not extend in the plane defined by the front-rear direction and the up-down direction, provided that the standing portion 320 extends upward from the ceiling surface 312 of the shell body 310. For example, the standing portion 320 may extend in a plane defined by the up-down direction and the lateral direction. Additionally, the standing portion 320 may extend in a direction intersecting with both the front-rear direction and the lateral direction. Each of the standing portions 320 extends straight in the up-down direction. However, the present invention is not limited thereto. Specifically, the standing portion 320 may extend in a direction intersecting with the up-down direction, provided that the standing portion 320 extends upward from the ceiling surface 312 of the shell body 310. Each of the standing portions 320 of the present embodiment has a flat-plate shape perpendicular to the lateral direction. However, the present invention is not limited thereto. Specifically, the standing portion 320 may have, for example, a rod or pillar shape.

As shown in FIG. 6, the connector body 200 has three receiving surfaces 250. However, the present invention is not limited thereto. Specifically, the connector body 200 should have at least three receiving surfaces 250.

As shown in FIG. 6, each of the receiving surfaces 250 of the present embodiment faces upward in the up-down direction. Each of the receiving surfaces 250 is a plane intersecting with the up-down direction. More in detail, each of the receiving surfaces 250 is the plane perpendicular to the up-down direction. One of the receiving surfaces 250 is provided on the ceiling surface 312 of the shell body 310.

As shown in FIG. 9, the connector body 200 is provided with regulating portions 260.

Referring to FIG. 9, the number of regulating portions 260 of the present embodiment is four. The four regulating portions 260 are grouped into two sets each consisting of two of the regulating portions 260. The two regulating portions 260 of each set are positioned at positions same as each other in the up-down direction. The two regulating portions 260 of each set are positioned at positions same as each other in the lateral direction. The two regulating portions 260 of each set are positioned away from each other in the front-rear direction.

As shown in FIG. 5, the connector body 200 further comprises an outer housing 210, an inner housing 220 and signal contacts 240. However, the present invention is not limited thereto. Specifically, the connector body 200 may have no outer housing 210.

As shown in FIG. 6, the outer housing 210 of the present embodiment is attached to the shielding shell 300. Referring to FIG. 7, the outer housing 210 is made of insulator. Remaining two of the three receiving surfaces 250 are provided on the outer housing 210. The outer housing 210 is provided with two recessed portions 212. The recessed portions 212 are positioned away from each other in the lateral direction. Each of the recessed portions 212 is recessed inward in the lateral direction. As shown in FIG. 9, each of the regulating portions 260 is a surface of the recessed portion 212 which faces in the front-rear direction. The recessed portion 212 also functions as an outer housing attached portion 212, or an attached portion 212. The outer housing attached portion 212 has an outer housing regulating surface 2122.

Referring to FIG. 9, the outer housing regulating surface 2122 of the present embodiment intersects with both the up-down direction and the lateral direction. More in detail, the outer housing regulating surface 2122 is oblique to both the up-down direction and the lateral direction. The outer housing regulating surface 2122 extends upward in the up-down direction and outward in the lateral direction.

As shown in FIG. 7, the outer housing 210 has a surrounding portion 214 and two hooking portions 216.

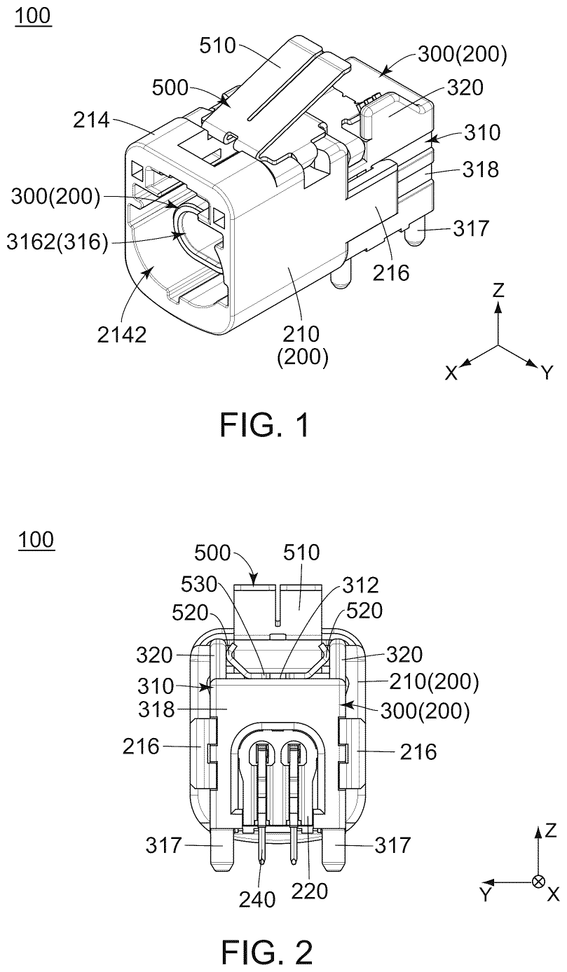

Referring to FIG. 5, the surrounding portion 214 of the present embodiment has a substantially rectangular tube shape extending in the front-rear direction. The surrounding portion 214 has an opening 2142 at its front end in the front-rear direction. As shown in FIG. 7, the surrounding portion 214 defines a front end of the outer housing 210 in the front-rear direction. As shown in FIG. 1, the surrounding portion 214 defines a front end of the shielded connector 100 in the front-rear direction. The front end of the surrounding portion 214 is positioned forward of the front end of the cylindrical portion 316 in the front-rear direction under a state where the outer housing 210 is attached to the shielding shell 300. The surrounding portion 214 surrounds the cylindrical portion 316 in a plane perpendicular to the front-rear direction under the state where the outer housing 210 is attached to the shielding shell 300. A rear end of the surrounding portion 214 faces a front end of the box-like portion 318 in the front-rear direction under the state where the outer housing 210 is attached to the shielding shell 300.

As shown in FIG. 7, each of the hooking portions 216 of the present embodiment extends rearward in the front-rear direction from the surrounding portion 214. Each of the hooking portions 216 is elastically deformable. Each of the hooking portions 216 defines a rear end of the outer housing 210 in the front-rear direction. Each of the hooking portions 216 has an engaging surface 2162 around its rear end.

As shown in FIG. 7, the engaging surface 2162 of the present embodiment faces forward in the front-rear direction. The engaging surface 2162 is movable outward in the lateral direction by the elastic deformation of the hooking portion 216. As shown in FIG. 4, when the outer housing 210 is attached to the shielding shell 300, the engaging surface 2162 is positioned rearward of the engaged surface 3155 in the front-rear direction and faces the engaged surface 3155 in the front-rear direction.

This prevents removal of the outer housing 210 from the shielding shell 300 even if a forward force is applied to the outer housing 210 attached to the shielding shell 300. It is noted that the aforementioned guide surface 315 guides the rear end of the hooking portion 216 when the outer housing 210 is attached to the shielding shell 300.

Referring to FIG. 5, the inner housing 220 of the present embodiment is made of insulator. As shown in FIG. 2, the inner housing 220 is positioned inside the shielding shell 300.

Referring to FIG. 5, each of the signal contacts 240 of the present embodiment is a pin contact made of metal. Referring to FIG. 2, the shielding shell 300 surrounds the signal contacts 240 with no gap in the plane perpendicular to the front-rear direction. More in detail, the shielding shell 300 surrounds the signal contacts 240 with no gap in the plane perpendicular to the front-rear direction under a state where the shielding shell 300 is insulated from any of the signal contacts 240 by the inner housing 220. The signal contact 240 is brought into contact with a mating contact (not shown) of the mating connector when the shielded connector 100 and the mating connector are mated with each other.

As shown in FIG. 5, each of the signal contacts 240 has a contact portion 242 around its front end. Referring to FIGS. 1 and 5, the contact portion 242 is positioned in the hollow part of the cylindrical portion 316. The cylindrical portion 316 surrounds the contact portions 242 with no gap in the plane perpendicular to the front-rear direction. The contact portion 242 is brought into contact with a mating contact portion (not shown) of the mating contact when the shielded connector 100 and the mating connector are mated with each other.

Referring to FIG. 5, the spring component 500 of the present embodiment is made of metal. The spring component 500 consists of a single metal plate. More specifically, the spring component 500 is formed by punching out a blank from a single metal plate, followed by bending the blank. The spring component 500 is distinct and separated from the shielding shell 300. As shown in FIG. 4, the spring component 500 is attached to the connector body 200. As shown in FIG. 2, each of the standing portions 320 is brought into contact with the spring component 500 when the spring component 500 is attached to the connector body 200. Specifically, each of the standing portions 320 is electrically connected to the spring component 500 under an attached state where the spring component 500 is attached to the connector body 200.

As shown in FIG. 17, the spring component 500 has a first spring 510, second springs 520 and a facing portion 530.

As shown in FIG. 19, the first spring 510 of the present embodiment defines a front end of the spring component 500 in the front-rear direction. The first spring 510 defines an upper end of the spring component 500 in the up-down direction. An upper end of the first spring 510 is a free end. The first spring 510 is resiliently deformable. Specifically, the first spring 510 is resiliently deformable downward in the up-down direction. More in detail, the first spring 510 is resiliently deformable downward in the up-down direction with its front end acting as a fulcrum. Accordingly, the upper end of the first spring 510 is movable downward in the up-down direction.

As shown in FIG. 3, the first spring 510 is folded so that its folded portion is positioned on the outer housing 210. The first spring 510 is brought into contact with the case 800 when the shielded connector 100 is used. Specifically, the first spring 510 is brought into contact with the case 800 in the up-down direction when the shielded connector 100 is used. More in detail, the upper end of the first spring 510 makes resilient contact with the case 800 from below in the up-down direction when the shielded connector 100 is used. However, the present invention is not limited thereto. Specifically, the first spring 510 may be brought into contact with the case 800 in the lateral direction when the shielded connector 100 is used.

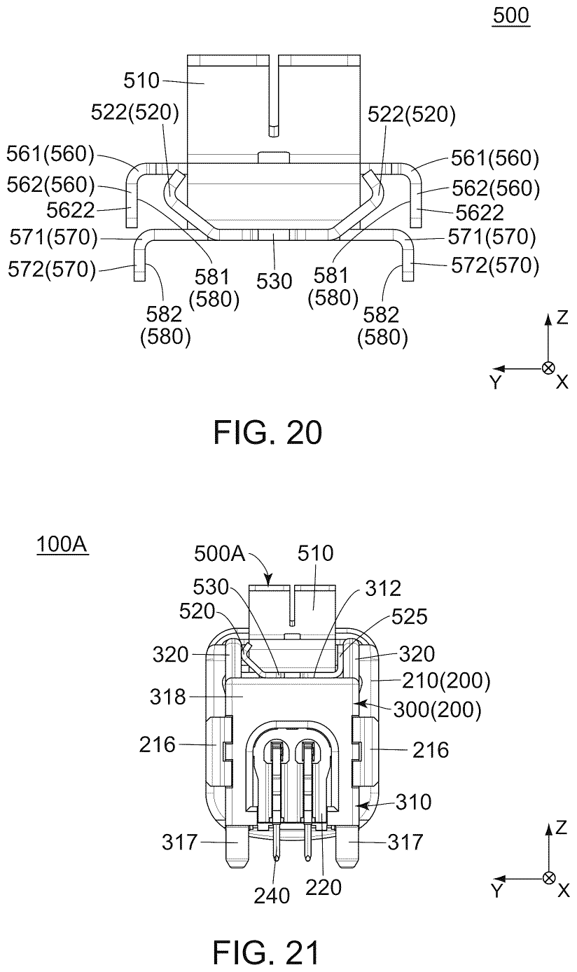

As shown in FIG. 19, each of the second springs 520 of the present embodiment defines a rear end of the spring component 500 in the front-rear direction. As shown in FIG. 20, an upper end of each of the second springs 520 is a free end. Each of the second springs 520 is resiliently deformable. Specifically, each of the second springs 520 is resiliently deformable inward in the lateral direction. More in detail, each of the second springs 520 is resiliently deformable inward in the lateral direction with its lower end acting as a fulcrum.

As shown in FIG. 17, the number of the second springs 520 is two. Each of the second springs 520 extends in the lateral direction from the facing portion 530. This simplifies a structure of the spring component 500. Additionally, this can reduce scrap metal that is produced when the spring component 500 is punched out from the metal plate.

As shown in FIG. 2, the second springs 520 are in contact with the standing portions 320, respectively. Under the attached state where the spring component 500 is attached to the connector body 200, the second springs 520 are in contact with the standing portions 320, respectively, in a direction intersecting with the up-down direction. More in detail, the second spring 520 is in contact with the standing portion 320 in the lateral direction. The second spring 520 is in contact with the standing portion 320 from its inside in the lateral direction under the attached state. However, the present invention is not limited thereto. Specifically, the second spring 520 may be in contact with the standing portion 320 from its outside in the lateral direction under the attached state.

As described above, the shielded connector 100 of the present embodiment is configured as follows: the two standing portions 320 are positioned away from each other in the lateral direction; each of the second springs 520 extends in the lateral direction from the facing portion 530; and the second springs 520 are in contact with the standing portions 320, respectively. This enables the second springs 520 to be in contact with the standing portions 320 at opposite sides, respectively, of the facing portion 530 in the lateral direction. Accordingly, the shielded connector 100 of the present embodiment is configured so that forces applied to the shielding shell 300 by the spring component 500 are properly balanced.

Referring to FIGS. 3 and 4, each of the standing portions 320 has a size greater than a size of any of the second springs 520 in a plane perpendicular to the lateral direction. Specifically, each of the standing portions 320 hides any of the second springs 520 when the shielded connector 100 is viewed from its outside in the lateral direction. The shielded connector 100 of the present embodiment has dimensions of about 2 cm in the front-rear direction and about 1 cm or more in the lateral direction. Accordingly, each of the second springs 520 of the present embodiment has a much smaller size and thus has lower strength. Hence, when a finger or the like of an assembler is brought into contact with the second spring 520 upon the attachment of the spring component 500 to the connector body 200, the second spring 520 might be deformed or broken. Meanwhile, the shielded connector 100 of the present embodiment has the standing portions 320 as described above. This prevents the finger or the like of the assembler from being brought into contact with the second spring 520 upon the attachment of the spring component 500 to the connector body 200. Thus, the second spring 520 is prevented from being deformed upon the attachment of the spring component 500 to the connector body 200.

As shown in FIG. 17, each of the second springs 520 has three resilient deformation portions 522. Referring to FIG. 20, each of the resilient deformation portions 522 extends in the lateral direction from the facing portion 530. More in detail, each of the resilient deformation portions 522 extends upward in the up-down direction and outward in the lateral direction from an outer end of the facing portion 530 in the lateral direction, and then extends upward in the up-down direction and inward in the lateral direction.

As shown in FIG. 20, the facing portion 530 of the present embodiment has a flat-plate shape intersecting with the up-down direction. More in detail, the facing portion 530 has the flat-plate shape perpendicular to the up-down direction. As shown in FIG. 17, the facing portion 530 is positioned rearward of the first spring 510 in the front-rear direction.

As shown in FIG. 2, the facing portion 530 is positioned between the two standing portions 320 in the lateral direction. The facing portion 530 is in contact with the ceiling surface 312 of the shell body 310 in the up-down direction under the attached state where the spring component 500 is attached to the connector body 200. However, the present invention is not limited thereto. Specifically, the shielded connector 100 may be configured so that the facing portion 530 is not in contact with but faces the ceiling surface 312 of the shell body 310 in the up-down direction under the attached state where the spring component 500 is attached to the connector body 200. In other words, the shielded connector 100 should be configured so that the facing portion 530 faces or is in contact with the ceiling surface 312 of the shell body 310 in the up-down direction under the attached state where the spring component 500 is attached to the connector body 200.

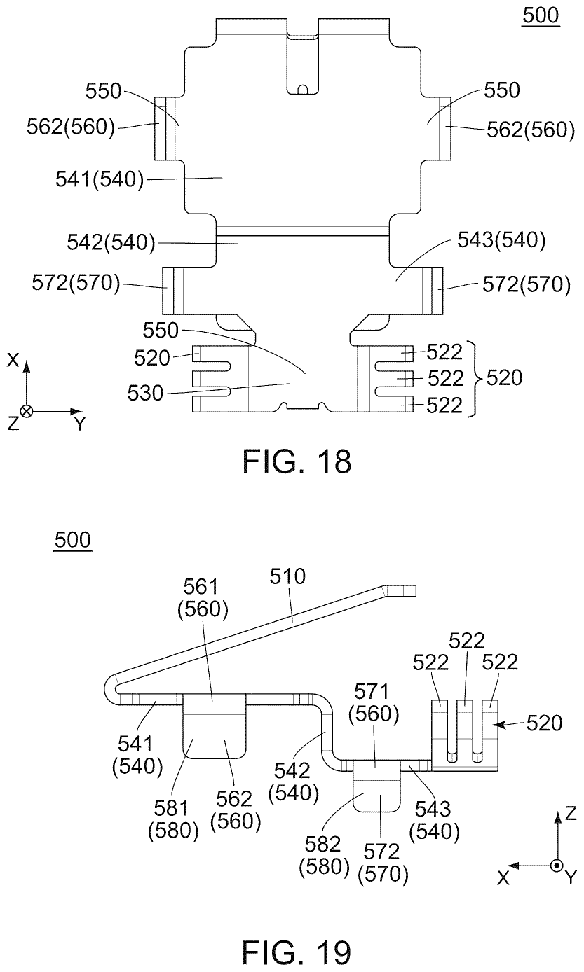

As shown in FIG. 18, the spring component 500 has a main portion 540.

As shown in FIG. 17, the main portion 540 of the present embodiment couples the first spring 510 and the facing portion 530 with each other. As shown in FIG. 18, the main portion 540 has a first portion 541, a second portion 542 and a third portion 543.

As shown in FIG. 19, the first portion 541 of the present embodiment has a flat-plate shape intersecting with the up-down direction. Specifically, the first portion 541 has the flat-plate shape perpendicular to the up-down direction. The first portion 541 couples the first spring 510 and the second portion 542 with each other.

As shown in FIG. 19, the second portion 542 of the present embodiment has a flat-plate shape intersecting with the front-rear direction. Specifically, the second portion 542 has the flat-plate shape perpendicular to the front-rear direction. The second portion 542 couples the first portion 541 and the third portion 543 with each other.

As shown in FIG. 19, the third portion 543 of the present embodiment has a flat-plate shape intersecting with the up-down direction. Specifically, the third portion 543 has the flat-plate shape perpendicular to the up-down direction. As shown in FIG. 18, the third portion 543 couples the second portion 542 and the facing portion 530 with each other.

As shown in FIG. 18, the spring component 500 has three pressing surfaces 550. However, the present invention is not limited thereto. Specifically, the spring component 500 should have at least three of the pressing surfaces 550.

As shown in FIG. 18, each of the pressing surfaces 550 of the present embodiment intersects with the up-down direction. Specifically, each of the pressing surfaces 550 is perpendicular to the up-down direction. Two of the three pressing surfaces 550 are provided on opposite ends, respectively, of the first portion 541 in the lateral direction. A remaining one of the three pressing surfaces 550 is provided on the facing portion 530. Referring to FIGS. 6 and 18, the pressing surfaces 550 correspond to the receiving surfaces 250, respectively. Each of the pressing surfaces 550 is positioned on the corresponding receiving surface 250 in the up-down direction.

Referring to FIGS. 6 and 18, when the spring component 500 is attached to the connector body 200, each of the pressing surfaces 550 of the spring component 500 is pressed against the corresponding receiving surface 250 of the connector body 200 by an assembling tool. In other words, the shielded connector 100 of the present embodiment is configured so that the spring component 500 is pressed against the connector body 200 at three points when the spring component 500 is attached to the connector body 200. Accordingly, the shielded connector 100 of the present embodiment is configured so that an attitude of the spring component 500, which is pressed against the connector body 200 by the assembling tool, is stabilized.

As described above, the shielded connector 100 of the present embodiment is configured as follows: the first spring 510 is folded so that its folded portion is positioned on the outer housing 210; and the remaining two of the three receiving surfaces 250 are provided on the outer housing 210. However, the present invention is not limited thereto. Specifically, the shielded connector 100 may be modified as follows: the shielded connector 100 comprises no outer housing 210; and all of the receiving surfaces 250 are provided on the shielding shell 300. Alternatively, the shielded connector 100 may be modified as follows: the first spring 510 is folded so that its folded portion is positioned on the shielding shell 300; and all of the receiving surfaces 250 are provided on the shielding shell 300.

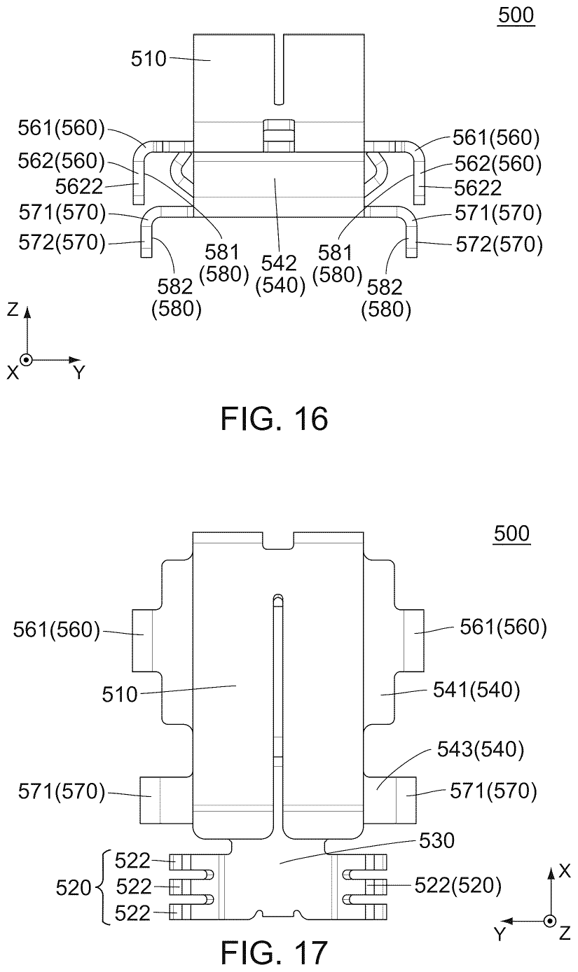

As shown in FIG. 16, the spring component 500 has two first extending portions 560 and two second extending portions 570.

As shown in FIG. 5, each of the first extending portions 560 of the present embodiment extends from an outer end of the first portion 541 in the lateral direction. More specifically, each of the first extending portions 560 extends outward in the lateral direction from the first portion 541, and is bent so that it extends downward in the up-down direction and inward in the lateral direction. As shown in FIG. 18, the two first extending portions 560 extend from the opposite ends, respectively, of the first portion 541 in the lateral direction. Each of the first extending portions 560 is positioned forward of the second portion 542 in the front-rear direction. As shown in FIG. 4, a part of the first extending portion 560 is accommodated in the recessed portion 212 when the spring component 500 is attached to the connector body 200.

As shown in FIG. 19, the first extending portion 560 has a first bent portion 561 and a first flat plate portion 562.

As shown in FIG. 5, the first bent portion 561 of the present embodiment defines an outer end of the first extending portion 560 in the lateral direction. As shown in FIG. 4, a part of the first bent portion 561 is accommodated in the recessed portion 212 when the spring component 500 is attached to the connector body 200.

As shown in FIG. 5, the first flat plate portion 562 of the present embodiment extends downward in the up-down direction and inward in the lateral direction from the first bent portion 561. The first flat plate portion 562 has a flat-plate shape intersecting with both the up-down direction and the lateral direction. Specifically, the first flat plate portion 562 has the flat-plate shape oblique to both the up-down direction and the lateral direction. As shown in FIG. 4, the first flat plate portion 562 is accommodated in the recessed portion 212 of the outer housing 210 when the spring component 500 is attached to the connector body 200.

As shown in FIG. 5, each of the second extending portions 570 of the present embodiment extends from an outer end of the third portion 543 in the lateral direction. More specifically, each of the second extending portions 570 extends outward in the lateral direction from the third portion 543, and is bent so that it extends downward in the up-down direction and inward in the lateral direction. As shown in FIG. 18, the two second extending portions 570 extend from opposite ends, respectively, of the third portion 543 in the lateral direction. Each of the second extending portions 570 is positioned rearward of the second portion 542 in the front-rear direction. Each of the second extending portions 570 is positioned forward of the facing portion 530 in the front-rear direction. As shown in FIG. 4, a part of the second extending portion 570 is accommodated in the shielding shell attached portion 314 when the spring component 500 is attached to the connector body 200.

As shown in FIG. 19, the second extending portion 570 has a second bent portion 571 and a second flat plate portion 572.

As shown in FIG. 5, the second bent portion 571 of the present embodiment defines an outer end of the second extending portion 570 in the lateral direction.

As shown in FIG. 5, the second flat plate portion 572 of the present embodiment extends downward in the up-down direction and inward in the lateral direction from the second bent portion 571. The second flat plate portion 572 has a flat-plate shape intersecting with both the up-down direction and the lateral direction. Specifically, the second flat plate portion 572 has the flat-plate shape oblique to both the up-down direction and the lateral direction. As shown in FIG. 4, a part of the second flat plate portion 572 is accommodated in the shielding shell attached portion 314 when the spring component 500 is attached to the connector body 200.

As shown in FIGS. 16 and 20, the spring component 500 is provided with regulated portions 5622.

As shown in FIGS. 16 and 20, the regulated portions 5622 of the present embodiment are provided on the first extending portions 560. More specifically, each of the regulated portions 5622 is a surface of the first flat plate portion 562 which faces in the front-rear direction. As shown in FIG. 3, the regulated portion 5622 faces regulating portion 260 in the front-rear direction under the attached state where the spring component 500 is attached to the connector body 200. Accordingly, the regulating portion 260 regulates a movement of the regulated portion 5622 in the front-rear direction perpendicular to the up-down direction.

As shown in FIG. 20, the spring component 500 is provided with attaching portions 580.

As shown in FIG. 20, the attaching portions 580 of the present embodiment are provided on the first extending portions 560 and the second extending portions 570. More specifically, each of the first flat plate portion 562 and the second flat plate portion 572 functions as the attaching portion 580. Referring to FIG. 4, a movement of the spring component 500 relative to the connector body 200 in the up-down direction is regulated when the attaching portions 580 are attached to the connector body 200. In particular, a movement of the facing portion 530 relative to the connector body 200 in the up-down direction is regulated when the attaching portions 580 are attached to the connector body 200. It is noted that none of movements of the first spring 510 and the second springs 520 is regulated even when the attaching portions 580 are attached to the connector body 200.

As shown in FIG. 16, the attaching portions 580 include two first attaching portions 581 and two second attaching portions 582.

As shown in FIG. 16, the first attaching portion 581 of the present embodiment is provided at the first extending portion 560. More specifically, the first flat plate portion 562 functions as the first attaching portion 581. Referring to FIGS. 3 and 9, the first attaching portion 581 faces the outer housing regulating surface 2122 under the attached state where the spring component 500 is attached to the connector body 200.

As shown in FIG. 16, the second attaching portion 582 of the present embodiment is provided at the second extending portion 570. More specifically, the second flat plate portion 572 functions as the second attaching portion 582. Referring to FIGS. 3 and 14, the second attaching portion 582 faces the shielding shell regulating surface 3142 under the attached state where the spring component 500 is attached to the connector body 200.

As described above, the shielded connector 100 is configured as follows: under the attached state where the spring component 500 is attached to the connector body 200, the first attaching portion 581 faces the outer housing regulating surface 2122 which extends upward in the up-down direction and outward in the lateral direction; and under the attached state where the spring component 500 is attached to the connector body 200, the second attaching portion 582 faces the shielding shell regulating surface 3142 which extends upward in the up-down direction and outward in the lateral direction. This configuration regulates a movement of the spring component 500 relative to the connector body 200 in the up-down direction. In other words, an upward movement of the spring component 500 is prevented even if an upward force is applied to the spring component 500 attached to the connector body 200.

Although the specific explanation about the present invention is made above referring to the embodiment, the present invention is not limited thereto and is susceptible to various modifications and alternative forms.

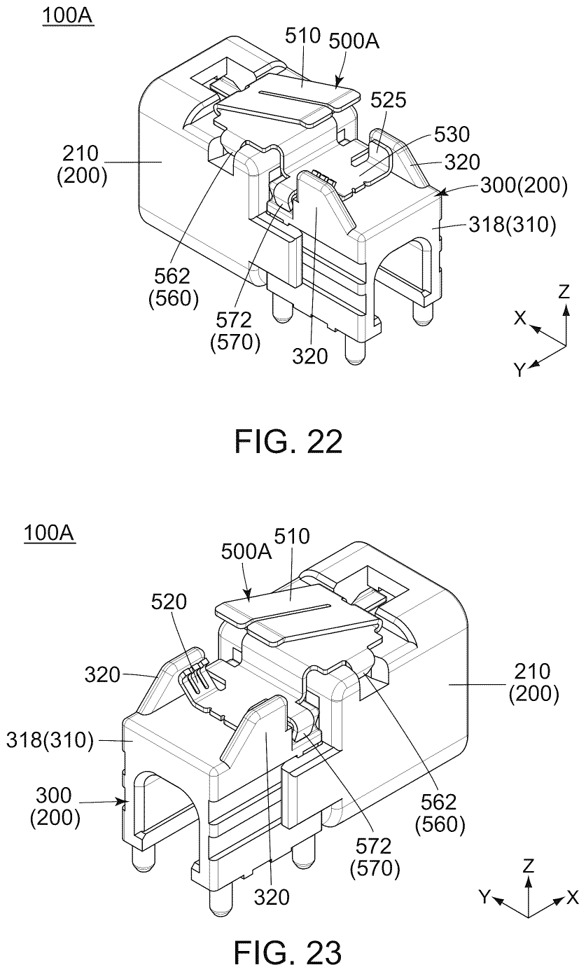

The shielded connector 100 of the aforementioned embodiment is configured as follows: the spring component 500 has the two second springs 520; and the two second springs 520 are in contact with the two standing portions 320, respectively, in the lateral direction under the attached state. However, the present invention is not limited thereto. For example, the shielded connector 100 may be modified similar to a shielded connector 100A of a first modification shown in each of FIGS. 21 to 23. In other words, the shielded connector 100 may be modified as follows: a spring component 500A has a single second spring 520 and a single abutment portion 525; the abutment portion 525 abuts against one of the two standing portions 320 in the lateral direction under an attached state where the spring component 500A is attached to the connector body 200; and the second spring 520 is in contact with a remaining one of the two standing portions 320 in the lateral direction under the attached state.

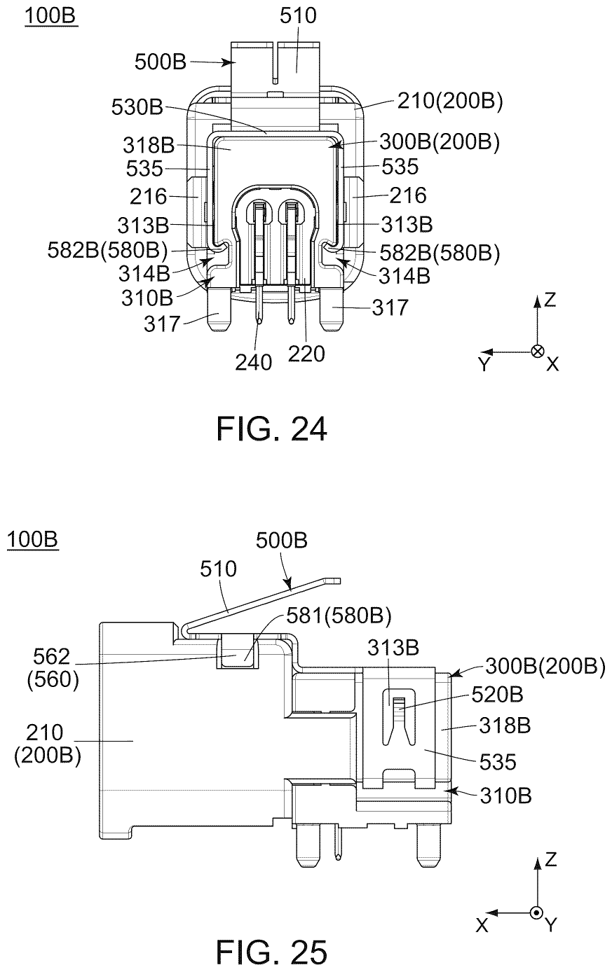

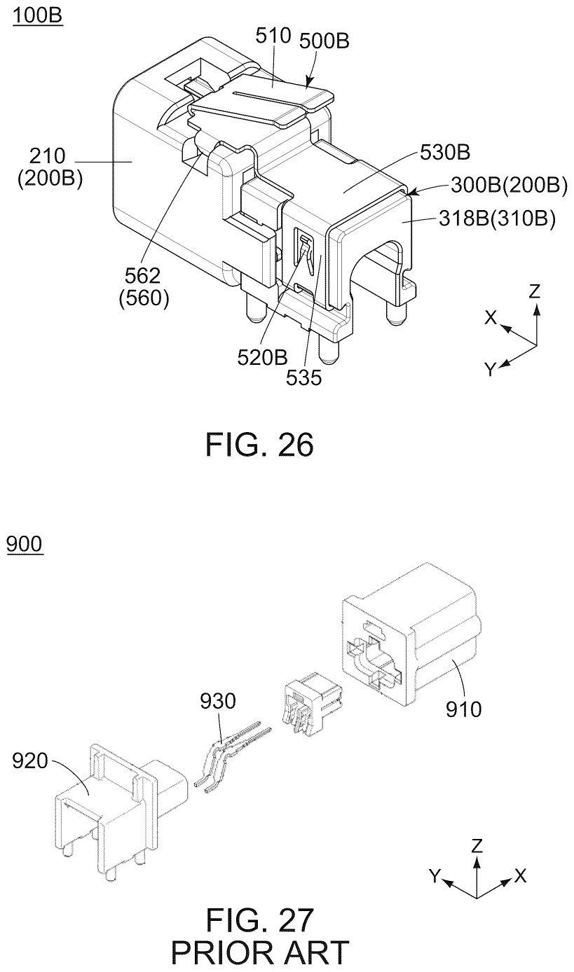

The shielded connector 100 of the aforementioned embodiment is configured as follows: the shielding shell 300 has the two standing portions 320 each extending upward from the ceiling surface 312 of the shell body 310; each of the second springs 520 of the spring component 500 extends upward in the up-down direction and outward in the lateral direction from the outer end of the facing portion 530 in the lateral direction, and then extends upward in the up-down direction and inward in the lateral direction; and the second springs 520 are in contact with the standing portions 320, respectively. However, the present invention is not limited thereto. For example, the shielded connector 100 may be modified similar to a shielded connector 100B of a second modification shown in each of FIGS. 24 to 26. In other words, the shielded connector 100 may be modified as follows: a shielding shell 300B of a connector body 200B has no standing portion 320; a spring component 500B has two extension portions 535 and two second springs 520B; the two extension portions 535 extends downward in the up-down direction from opposite ends, respectively, of a facing portion 530B in the lateral direction; the second spring 520B extends upward in the up-down direction and inward in the lateral direction from the extension portions 535, and then extends upward in the up-down direction and outward in the lateral direction; and the second springs 520B are in contact with side portions 313B, respectively, of a shell body 310B of the shielding shell 300B. In this case, a second attaching portion 582B of an attaching portion 580B is provided at a lower end of the extension portion 535 while a shielding shell attached portion 314B, or an attached portion 314B, is provided at a lower part of a box-like portion 318B of the shell body 310B.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is

1. A shielded connector comprising a connector body and a spring component, wherein:
the shielded connector is, at least in part, accommodated in a case when the shielded connector is used;
the connector body comprises a shielding shell made of die cast metal;
the shielding shell has a shell body and a standing portion;
the shell body has a ceiling surface;
the standing portion extends upward in an up-down direction from the ceiling surface;
the spring component is attached to the connector body;
the spring component has a first spring, a second spring and a facing portion;
the first spring is resiliently deformable;
the first spring is brought into contact with the case when the shielded connector is used;
the second spring is resiliently deformable;
under an attached state where the spring component is attached to the connector body, the second spring is in contact with the standing portion in a direction intersecting with the up-down direction; and
under the attached state, the facing portion faces or is in contact with the ceiling surface in the up-down direction.

2. The shielded connector as recited in claim 1, wherein:
the shielding shell is provided with two of the standing portions;
the two standing portions are positioned away from each other in a lateral direction perpendicular to the up-down direction;
the facing portion is positioned between the two standing portions in the lateral direction; and
the second spring is in contact with the standing portion in the lateral direction.

3. The shielded connector as recited in claim 2, wherein:
each of the standing portions has a size greater than a size of the second spring in a plane perpendicular to the lateral direction; and
each of the standing portions hides the second spring when the shielded connector is viewed from its outside in the lateral direction.

4. The shielded connector as recited in claim 2, wherein the second spring extends in the lateral direction from the facing portion.

5. The shielded connector as recited in claim 2, wherein:
the spring component has two of the second springs; and
the second springs are in contact with the standing portions, respectively.

6. The shielded connector as recited in claim 1, wherein:
the connector body has at least three receiving surfaces;
the spring component has at least three pressing surfaces;
the pressing surfaces correspond to the receiving surfaces, respectively; and
each of the pressing surfaces is positioned on the corresponding receiving surface in the up-down direction.

7. The shielded connector as recited in claim 1, wherein:
the spring component is provided with a regulated portion;
the connector body is provided with a regulating portion; and
the regulating portion regulates a movement of the regulated portion in a front-rear direction perpendicular to the up-down direction.

8. The shielded connector as recited in claim 1, wherein:
the spring component is provided with an attaching portion; and
a movement of the spring component relative to the connector body in the up-down direction is regulated when the attaching portion is attached to the connector body.

9. A shielded connector comprising a connector body and a spring component, wherein:
the shielded connector is, at least in part, accommodated in a case when the shielded connector is used;
the connector body comprises a shielding shell made of die cast metal;
the shielding shell has a shell body;
the shell body has a ceiling surface;
the spring component is attached to the connector body;
the spring component has a first spring, a second spring and a facing portion;
the first spring is resiliently deformable;
the first spring is brought into contact with the case when the shielded connector is used;
the second spring is resiliently deformable;
under an attached state where the spring component is attached to the connector body, the second spring is in contact with the shielding shell in a direction intersecting with the up-down direction; and
under the attached state, the facing portion faces or is in contact with the ceiling surface in the up-down direction.

10. A connector body which can form a shielded connector by attaching a spring component to the connector body, wherein:
when the shielded connector is used, the shielded connector is, at least in part, accommodated in a case and is connected to the case;
the connector body comprises a shielding shell made of die cast metal;
the shielding shell has a shell body and a standing portion;
the shell body has a ceiling surface;
the standing portion extends upward in an up-down direction from the ceiling surface; and
the standing portion is brought into contact with the spring component when the spring component is attached to the connector body.
